(19) United States
(12) Patent Application Publication
(10) Pub. No.: US 2018/0041794 A1
(43) Pub. Date: Feb. 8, 2018

(54) DIGITAL ON-SCREEN GRAPHIC GENERATOR SYSTEMS AND METHODS

(71) Applicant: SCOREPAD SPORTS, INC., Decatur, GA (US)

(72) Inventor: Douglas Hines, SR., Lithonia, GA (US)

(21) Appl. No.: 15/227,094

(22) Filed: Aug. 3, 2016

(51) Int. Cl. H04N 21/431; G06F 3/0484; H04N 21/81; G06F 3/0488

(52) U.S. Cl. CPC H04N 21/4312; G06F 3/04883; G06F 3/04842; G06F 3/04845; H04N 21/8173

(57) ABSTRACT

Digital on-screen graphic generator systems and methods. The system may include a mobile computing device and a generator computing device. The mobile computing device may include a processor and a memory including instructions that upon execution by the processor generate an event application configured to receive input representing one or more of selection, arrangement, and content of a first digital on-screen graphic, and output event-agnostic data for the first digital on-screen graphic. The generator computing device may receive the event-agnostic data for the first digital on-screen graphic, and may include a processor and a memory including instructions that upon execution generate a rendering application. The rendering application may be configured to receive the event-agnostic data for the first digital on-screen graphic from the mobile computing device. The rendering application may be further configured to generate the first digital on-screen graphic from the event-agnostic data for the first digital on-screen graphic.

### BACKGROUND

### 1. Field

Embodiments of the present invention relate generally to the field of video production and particularly to improved digital on-screen graphic generator systems and methods.

### 2. Description of the Related Art

A digital on-screen graphic or bug take the form of text, images, animations, audio, and other overlays that are added to an underlying video. Conventionally, the digital on-screen graphic may be created using a generator. The generator may output a generator output signal to a video switcher which may then key (i.e., add) the created digital on-screen graphic to the underlying video signal resulting in a keyed video signal.

The use of digital on-screen graphics, or score bugs as they are commonly known, is prevalent in broadcast sports. Sports related text (e.g., scores, elapsed time, and innings), images (e.g., team logos and player photographs), animations (e.g., a homerun animation or a touchdown animation), audio (e.g., the sound of a bat hitting a ball), and other overlays are added to a portion of the underlying sporting event video. As an example, a broadcast baseball game may include numerous overlays throughout the game. When a player first takes to bat, digital on-screen graphics in the form of text showing the player's name and an image showing the logo of the player's team may be generated by a generator and added by a video switcher over a video signal showing home plate resulting in a keyed video signal showing home plate with the player's name (text) and the team logo (image). If the player misses the ball when swinging, an animated strike digital on-screen graphic may be created by the generator and added by the video switcher to the video signal showing home plate resulting in the keyed video signal showing home plate and the animated strike digital on-screen graphic (animation). If the player hits a homerun, an animated homerun digital on-screen graphic may be added to the video signal showing the ball flying through the air and into the seats. The video signal may be from the same camera originally showing home plate or may be from a different camera. The result may be the keyed video signal showing the ball flying through the air and the animated homerun digital on-screen graphic (animation). Such digital on-screen graphics may be overlaid the underlying video throughout the game.

As far as the systems used for creating and generating digital on-screen graphics, a production truck will typically be parked at the venue of the sporting event. The production truck may include equipment for editing video signals and for producing a broadcast event (e.g., a televised sporting event or a webcast concert event). For example, the production truck may include a wall of video monitors for displaying the output of various cameras, a video mixer which may consist of a rack-mounted computing device, as well as one or more generators which each usually consist of a rack-mounted computing device. An operator of a generator may sit or stand at the rack-mounted computing device and input commands (e.g., via a keyboard and pointing device) to create and arrange digital on-screen graphics. The generator then uses the inputs of the operator to generate the digital on-screen graphics that are then sent as a generator output signal to the video switcher. The video switcher then adds (i.e., keys) the generator output signal to the underlying video signal resulting in a keyed video signal which may be broadcast for viewing. When multiple digital on-screen graphics are desirable (e.g., in upper and lower portions of the screen), multiple channels of digital on-screen graphics may be produced by multiple generators and then keyed to the underlying video signal.

The conventional approach to generating digital on-screen graphics for addition to video presents problems recognized by the present inventor and described more herein. Accordingly, an improved approach to generating digital on-screen graphics for addition to video is desirable.

### BRIEF SUMMARY

It is an aspect of the present invention to provide an improved approach to creating and arranging digital on-screen graphics for addition to video.

It is a further aspect of the present invention to provide improved digital on-screen graphic generator systems and methods.

According to an aspect of the present invention, a digital on-screen graphic generator system may be provided. The digital on-screen graphic generator system may include a mobile computing device and a generator computing device. The mobile computing device may include a mobile device processor and a mobile device memory including instructions that upon execution by the mobile device processor generate an event application that may be configured to receive input representing one or more of selection, arrangement, and content of a first digital on-screen graphic, and output event-agnostic data for the first digital on-screen graphic. The generator computing device may be configured to receive the event-agnostic data for the first digital on-screen graphic from the mobile computing device, and may include a generator processor and a generator memory including instructions that upon execution by the generator processor generate a rendering application. The rendering application may be configured to generate the first digital on-screen graphic from the event-agnostic data for the first digital on-screen graphic.

According to another aspect of the present invention, a method for generating digital on-screen graphics may be provided. The method may include the operation of receiving, into an event application of a mobile computing device, input representing one or more of selection, arrangement, and content of a first digital on-screen graphic. The mobile computing device may include a mobile device processor and a mobile device memory including instructions that upon execution by the mobile device processor generate the event application. The method may further include the operation of outputting, from the mobile computing device, event agnostic data for the first digital on-screen graphic. The method may further include the operation of receiving, into a generator computing device, the event agnostic data for the first digital on-screen graphic. The generator computing device may include a generator processor and a generator memory including instructions that upon execution by the generator processor generate a rendering application. The method may further include the operation of generating, using the rendering application, the first digital on-screen graphic from the event agnostic data for the first digital on-screen graphic.

The foregoing and other aspects will become apparent from the following detailed description when considered in conjunction with the accompanying drawing figures.

### BRIEF DESCRIPTION OF THE DRAWINGS

FIG. 1 is a schematic representation of a digital on-screen graphic generator system according to an exemplary embodiment of the present invention.

FIG. 2A is a schematic representation of a mobile computing device according to an exemplary embodiment of the present invention.

FIG. 2B is a schematic representation of a generator computing device according to an exemplary embodiment of the present invention.

FIG. 3 is a flowchart of an exemplary method for generating a digital on-screen graphic according to an exemplary embodiment of the present invention.

FIG. 4 is a schematic representation of an exemplary dataflow according to an exemplary embodiment of the present invention.

FIG. 5A is a schematic representation of a keyed video output containing no digital on-screen graphic.

FIG. 5B is a schematic representation of the keyed video output containing a digital on-screen graphic.

### DESCRIPTION

Reference will now be made in detail to embodiments of the present invention, examples of which are illustrated in the accompanying drawings, wherein like reference numerals refer to the like elements throughout. The embodiments are described below to explain the present invention by referring to the figures.

As used in the description of this application, the terms “a”, “an” and “the” may refer to one or more than one of an element (e.g., item or act). For example, references to “a mobile computing device” may refer to one or more than one mobile computing device. Similarly, a particular quantity of an element may be described or shown while the actual quantity of the element may differ. For example, although a single processor may be shown or described, more than one processor may be provided. The terms “and” and “or” may be used in the conjunctive or disjunctive sense and will generally be understood to be equivalent to “and/or”. Elements from an embodiment may be combined with elements of another. Elements described as separate elements may be combined into a single element. For example, although operating memory (e.g., Random Access Memory (RAM)) may be shown and described as being separate from long term memory (e.g., Solid State Drive (SSD) memory, Hard Disk Drive (HDD) memory), it is conceivable that memory could be configured to serve as the operating memory and long term memory. Similarly, an element described as single element may be split into two or more elements. No element used in the description of this application should be construed as critical or essential to the invention unless explicitly described as such. Further, when an element is described as “connected,” “coupled,” or otherwise linked to another element, it may be directly linked to the other element, or intervening elements may be present.

As noted above, the conventional approach to adding digital on-screen graphics to video presents problems recognized by the present inventor. For example, an operator must sit or stand at a generator computing device. This inhibits the operator's ability to move about within and outside of the production truck, even if the user is using a hardwired portable interface for the generator computing device. In addition, the generator computing device is typically only operable by a single operator at any given time. This may limit the quality and/or quantity of inputs resulting in digital on-screen graphics. Another significant drawback is the required computational power required by conventional generator computing devices. For example, the processing power of the generator computing device must be substantial due to the various functions performed by the generator computing device. The operator interactions with the generator computing device (e.g., input commands to create and arrange the digital on-screen graphics) consume processing resources. In addition, generation of the digital on-screen graphics and output of the generator output signal to be transmitted to the digital video switcher consumes even more processing resources of the generator computing device. This problem is compounded when multiple channels of digital on-screen graphics are desired thus requiring additional generator computing devices. Accordingly, the cost of generator computing devices including the required computational resources to achieve acceptable performance is high, and the performance may still leave much to be desired. In fact, the number of channels possible may be limited by the computing power of existing generator computing devices.

An improved approach to generating digital on-screen graphics for addition to video has been developed by the present inventor. In accordance with an exemplary embodiment of the present invention, a digital on-screen graphic system including a mobile computing device and a generator computing device may be provided. The mobile computing device and the generator computing device may both include a copy of an event database. An event application executed by the mobile computing device may be used to create and arrange digital on-screen graphics from among predetermined digital on-screen graphics (e.g., preexisting graphic components) within the specific application. The selection, arrangement, and content of a digital onscreen graphic may be received into the event application, which may be event specific. However, the selection, arrangement, and content data may be mapped from event specific data to event-agnostic data and stored in the event database stored on the mobile computing device. Updates (e.g., selection of a new digital on-screen graphic) to the event database stored on the mobile computing device trigger communication of the updated event-agnostic data from the mobile computing device to the generator computing device so as to update data stored on the generator computing device. Updates to the data stored on the generator computing device may result in, e.g., the addition of digital on-screen graphics (e.g., the selected new digital on-screen graphic) to the underlying video resulting in an overlaid video signal.

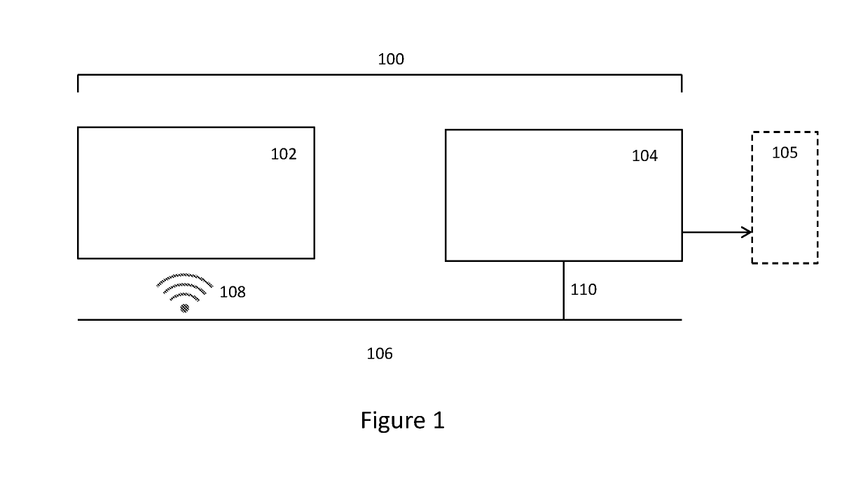

FIG. 1 is a schematic representation of a digital on-screen graphic generator system 100 according to an exemplary embodiment of the present invention. The digital on-screen graphic system 100 may include a mobile computing device 102 and a generator computing device 104. The mobile computing device 102 and the generator computing device 104 may be connected to a common network 106. The common network 106 may be a local area network 106. Although the common network 106 is shown in FIG. 1 as being a local area network, one of ordinary skill in the art will recognize that alternative configurations are possible. For example, the common network 106 may be wide area network, a group of interconnected networks, or the Internet. Such alternatives are considered to be within the scope of the present invention. Further, a computing device other than the mobile computing device 102 (e.g., a desktop computing device) may be employed. Such alternatives are considered to be within the scope of the present invention.

The mobile computing device 102 may be connected to the common network 106 via a wireless communication link 108. For example, the wireless communication link 108 may be established between the mobile computing device 102 and the common network 106 according to an IEEE 802.11 standard. The generator computing device 104 may be connected to the common network 106 via a wired communication link 110. For example, the wired communication link 110 may be an Ethernet connection according to IEEE 802.3. Although mobile computing device 102 and the generator computing device 104 are shown in FIG. 1 as being connected to the common network 106 via a wireless and wired connection, respectively, one of ordinary skill in the art will recognize that alternative configurations are possible. For example, the mobile computing device 102 and generator computing device 104 may be connected to the common network 106 via wired and wireless connections, respectively, or via all wired connections or all wireless connections. Such alternatives are considered to be within the scope of the present invention.

For the sake of context, FIG. 1 also shows a video switcher 105. The video switcher may receive one or more generator output signals (i.e., one or more channels of video and audio output from the generator computing device 104). The generator output signals may be received via video interfaces of the generator computing device 104 and the video switcher 105. The video interfaces may be High-Definition Serial Digital Interfaces (HD-SDIs). The video switcher 105 may key the one or more generator output signals to a video signal (e.g., a video signal of the underlying video). Although a separate video switcher 105 is shown in FIG. 1, one of ordinary skill in the art will recognize that alternative configurations are possible. For example, the generator computing device may be configured to key digital on-screen graphics to a video signal. Such alternatives are considered to be within the scope of the present invention.

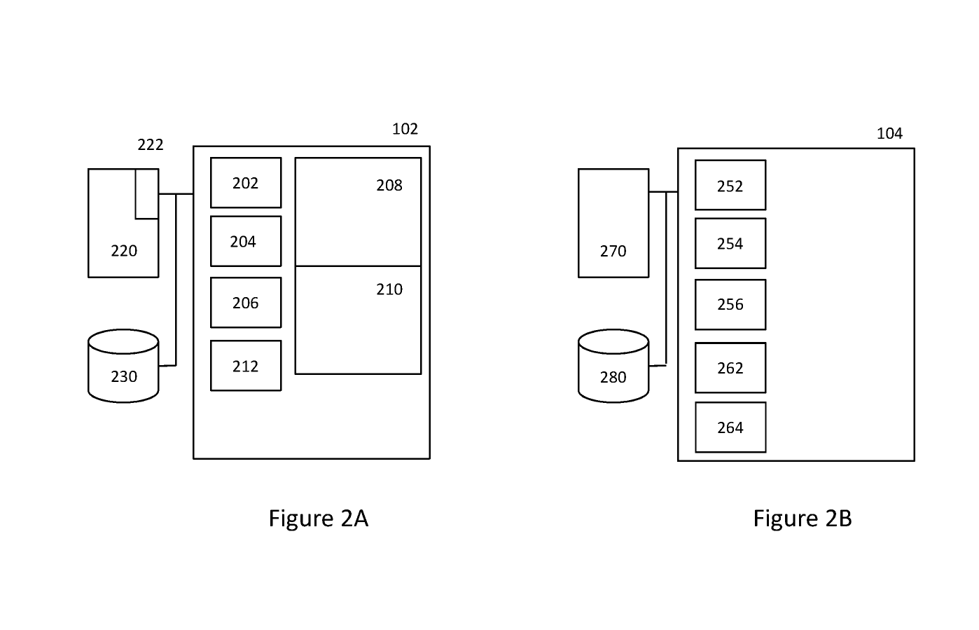

FIG. 2A is a schematic representation of a mobile computing device 102 according to an exemplary embodiment of the present invention. The mobile computing device 102 may take many embodiments, including, not by way of limitation, a laptop computing device, a tablet computing device, or a mobile phone computing device. The mobile computing device 102 may include a processor 202, operating memory 204 (e.g., RAM), long term memory 206 (e.g., a SSD), a user input device 208, a user output device 210, and a network interface device 212.

In a laptop computing device configuration, the user input device 208 may be embodied as one or more of a keyboard, a pointing device (e.g., a mouse or a touchpad), and a touch screen laptop display. The user output device 210 may be embodied as a laptop display (e.g., the touch screen laptop display). In a tablet computing device or mobile phone computing device configuration, the user input device 208 may be embodied as one or more of a keyboard, a pointing device (e.g., a mouse or a touchpad), and a touch screen tablet or phone display. The user output device 210 may be embodied as the touch screen tablet or phone display. The network interface device 212 may be embodied as a wireless network interface.

The processor 202 may execute instructions stored in the operating memory 204 and long term memory 206 to execute an event application 220 and an event database 230. The event application 220 may receive input representing selection and arrangement of digital on-screen graphics. The selection and arrangement of digital on-screen graphics may be from among predetermined digital on-screen graphics (e.g., the selection may be from a library of already-created digital on-screen graphics).

The selection, arrangement, and content (i.e., value) of a digital on-screen graphic may be stored using Hot Fields that may be event specific. For example, in a database corresponding to a baseball game, a baseball team's name may be received as a textual data value within a Hot Field named HomeTeam when that baseball team is the home team for the baseball game. An example of the content that may be received into the HomeTeam Hot Field is ATL which may correspond to the Atlanta Braves baseball team. The event application 220 may include a mapping 222 of Hot Fields to Universally Unique Identifiers (UUIDs). A UUID may be a field that may receive content and that may include information instructing how content within that particular UUID is to be arranged. UUIDs may take a standard format (e.g., “123e4567-e89b-12d3-a456-426655440000”), may be of a particular bit value (e.g., 128-bits), and may include certain values and flags. A high-level discussion of mapping to UUID's is provided for ease of discussion herein. For example, the Hot Field HomeTeam may be discussed as being mapped to a UUID named Field 1.

Hot Fields from different event applications may, in some cases, be mapped to the same UUID. In this way, the UUIDs may be event-agnostic. The Hot Field HomeTeam from a baseball event database and the Hot Field Pianist from a concert event may both map to the same UUID (e.g., Field 1). The UUIDs are stored in the event database 230. When content within the event database 230 changes, those updates may be communicated from mobile computing device to the generator computing device so as to update the event database 280 stored on the generator computing device 104. The event application 220 may monitor for and communicate changes within the event database 230. One of ordinary skill in the art will recognize that alternative configurations are possible. For example, a separate application or the event database 230 itself may monitor for and communicate changes within the event database 230. Such alternatives are considered to be within the scope of the present invention.

FIG. 2B is a schematic representation of a generator computing device 104 according to an exemplary embodiment of the present invention. The generator computing device 104 may take many embodiments, including, not by way of limitation, a server computing device, a desktop computing device, or a laptop mobile computing device. The generator computing device 104 may include a processor 252, operating memory 254 (RAM), long term memory 256 (a HDD), a network interface device 262, and a video interface 264.

The processor 252 may execute instructions stored in the operating memory 254 and the long term memory 256 to execute a rendering application 270 and an event database 280. The event database 280 of the generator computing device (104) may contain data identical to or corresponding to the event database 230 of the mobile computing device 102.

The event database 280 may receive updates from the mobile computing device 102. Updates to the event database 280 stored on the generator computing device 104 may result in the rendering application 270 creating a digital on-screen application that is output as a generator output signal. One or more generator output signals (e.g., channels including video and audio) may be output to the video switcher 105. The generator output signals may be output through the video interface 264 of the generator computing device 104 and input into a video interface of the video switcher 105.

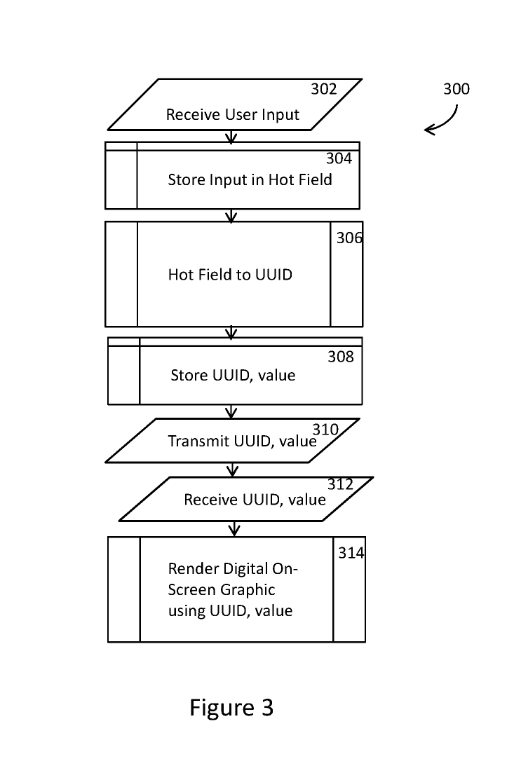

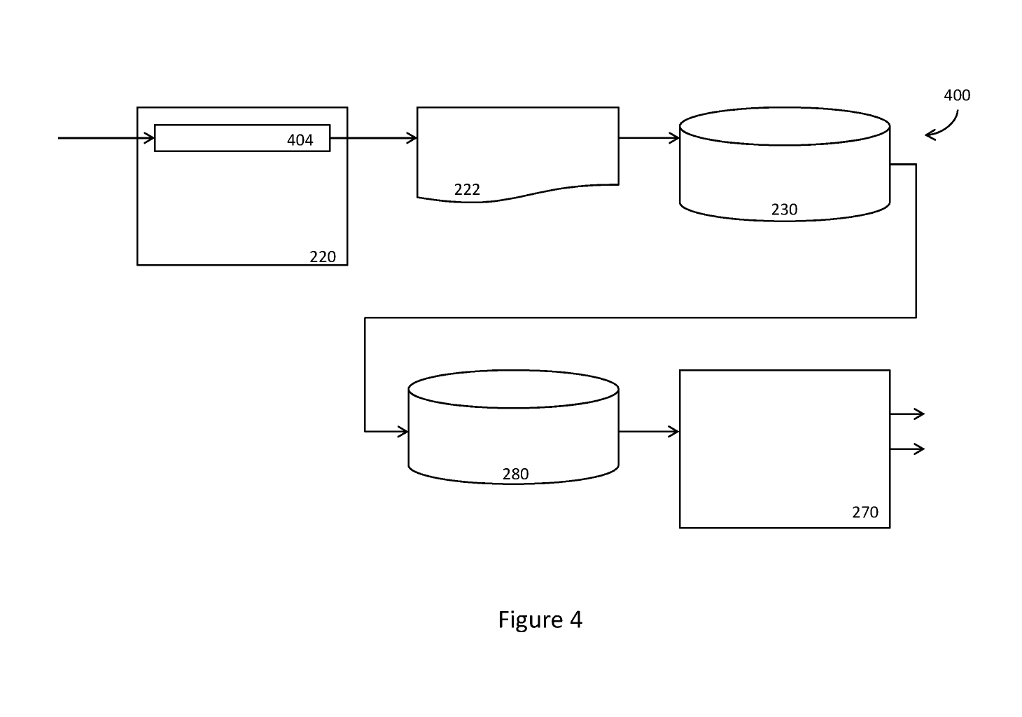

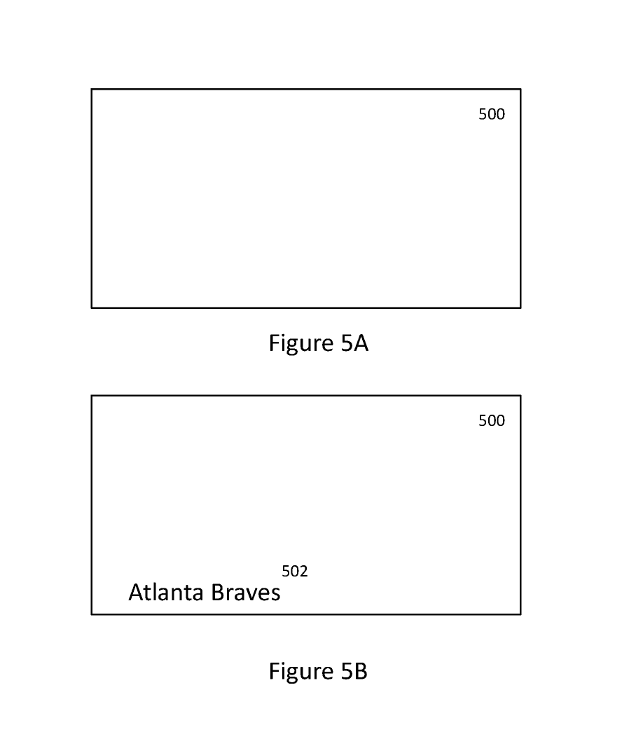

FIG. 3 is a flowchart of an exemplary method 300 for generating a digital on-screen graphic according to an exemplary embodiment of the present invention. FIG. 4 is a schematic representation of an exemplary dataflow 400 according to an exemplary embodiment of the present invention. FIG. 5A is a schematic representation of a keyed video output containing no digital on-screen graphic. FIG. 5B is a schematic representation of the keyed video output containing a digital on-screen graphic.

One of ordinary skill in the art will recognize that the method 300, dataflow 400, and video outputs involve generation of a simple text digital on-screen graphic. A simple text digital on-screen graphic is discussed in the interest of brevity of the disclosure. Alternative and more complex digital on-screen graphics (e.g., images, animations, audio, and other overlays) may result from the same or similar methods and dataflows.

In operation 302, operator input 404 may be received indicating a digital on-screen graphic to display. An operator using the mobile computing device 200 may be using the event application 220. The operator may make a selection within the event application 220. For example, the operator may select a button within the event application 220 corresponding to a command to input the name of the home team in a baseball game. The operator may input the text “ATL”. The text “ATL” may correspond to the Atlanta Braves baseball team.

In operation 304, the operator input 404 may be stored in a Hot Field in the event application 220. For example, the operator input text “ATL” may be stored in a Hot Field named HomeTeam.

In operation 306, the event application 220 may map the Hot Field to a Universally Unique Identifier (UUID). For example, the Hot Field Home Team may be mapped to the UUID Field 1 using the mapping 222 of the event application 220.

In operation 308, the operator input 404 may be stored in the event database 230 using the UUID. For example, the operator input text “ATL” may be stored in the event database 230 using the UUID Field 1. Additional information may be stored with the text (i.e., value) and UUID. For example, a display/hidden flag may be stored with the UUID.

In operation 310, the new value (i.e., text “Atlanta Braves”) stored within the UUID in the event database 230 may be communicated from the mobile computing device 102 to the generator computing device 104. That is, changes or updates to the event database 230 may be communicated upon occurrence from the mobile computing device 102 to the generator computing device 104. For example, the operator input text “ATL” upon being stored within the event database 230 with UUID Field 1 (including the value “Atlanta Braves”) may be communicated by the event application 220 to the generator computing device 104. Although communication of changes are described as occurring upon occurrence, one of ordinary skill in the art will recognize that alternative configurations are possible. For example, changes may be communicated periodically. For example, changes may be communicated every second or every tenth of a second. Such alternatives are considered to be within the scope of the present invention.

In operation 312, the generator computing device 104 may receive the changes to the event database 230. The received changes may result in an updating of the event database 280 stored on the generator computing device 104. For example, the event database 280 may be updated to include the UUID Field 1 (including the value “Atlanta Braves”), and the display/hidden flag.

In operation 314, a rendering application 270 running on the generator computing device 104 may render a digital on-screen graphic based on the UUID and its value. For example, rendering application 270 may generate a digital on-screen graphic including text reading “Atlanta Braves” 502 based on the received UUID Field 1 including the value “Atlanta Braves”, and a display flag.

Embodiments of the present invention provide an improved approach to adding digital on-screen graphics to video. Embodiments of the present invention may provide for a number of benefits. For example, an operator no longer must sit or stand at a rack-mounted generator computing device within a production truck. Instead, an operator may use the mobile computing device untethered from the production truck to input commands to create and arrange digital on-screen graphics. For example, the operator may be located in the broadcast booth or the stands while inputting commands using the mobile computing device. The mobile computing device may communicate with the generator computing device to generate digital on-screen graphics. As an additional benefit, multiple operators using multiple mobile devices may communicate with the generator computing device in generating the digital on-screen graphics, which may lead to richer digital on-screen graphics. As an additional benefit, by selecting from among predetermined digital on-screen graphics, and by separating the operator input function from the generator rendering function using the mobile computing device and the generator computing device, the computational efficiency of the digital on-screen graphic generator system is increased.

The foregoing description discloses only exemplary embodiments of the invention. Modifications of the above-disclosed embodiments of the present invention (beyond those modifications already mentioned) of which fall within the scope of the invention will be readily apparent to those of ordinary skill in the art.

Accordingly, although embodiments of the present invention have been shown and described, it would be appreciated by those skilled in the art that changes may be made in these embodiments without departing from the principles and spirit of the invention.

1. A digital on-screen graphic generator system, comprising:
a mobile computing device including a mobile device processor and a mobile device memory including instructions that upon execution by the mobile device processor generate an event application configured to receive input representing one or more of selection, arrangement, and content of a first digital on-screen graphic, and output event-agnostic data for the first digital on-screen graphic; and
a generator computing device configured to receive the event-agnostic data for the first digital on-screen graphic from the mobile computing device, the generator computing device including a generator processor and a generator memory including instructions that upon execution by the generator processor generate a rendering application configured to generate the first digital on-screen graphic from the event-agnostic data for the first digital on-screen graphic.

2. The digital on-screen graphic generator system of claim 1, wherein the generator computing device is configured to output a first generator output signal including the first digital on-screen graphic for keying to a video signal.

3. The digital on-screen graphic generator system of claim 1, wherein the generator computing device is configured to key the first digital on-screen graphic to a video signal.

4. The digital on-screen graphic generator system of claim 2,
wherein the first generator output signal corresponds to a first channel,
wherein the event application is further configured to receive input representing one or more of selection, arrangement, and content of a second digital on-screen graphic, and to output event-agnostic data for the second digital on-screen graphic,
wherein the generator computing device is further configured to receive the event-agnostic data for the second digital on-screen graphic from the mobile computing device, and
wherein the rendering application is further configured to generate the second digital on-screen graphic from the event-agnostic data for the second digital on-screen graphic, and to output a second generator output signal including the second digital on-screen graphic for keying to the video signal,
wherein the second generator output signal corresponds to a second channel.

5. The digital on-screen graphic generator system of claim 1,
wherein the event application is further configured to receive the input representing the one or more of selection, arrangement, and content of the first digital on-screen graphic as event specific data; and
wherein the mobile device processor and mobile device memory further include instructions that upon execution by the mobile device processor generate an event database configured to receive said event-agnostic data for the first digital on-screen graphic.

6. The digital on-screen graphic generator system of claim 1, further comprising a common network, wherein the mobile computing device and the generator computing device are communicatively connected via the common network.

7. The digital on-screen graphic generator system of claim 6, wherein the mobile computing device is communicatively connected to the common network via a wireless connection.

8. The digital on-screen graphic generator system of claim 1, wherein the mobile computing device further includes a touch screen display to receive the input representing the one or more of selection, arrangement, and content of the first digital on-screen graphic, and
wherein the generator computing device comprises a rack-mounted computing device.

9. The digital on-screen graphic generator system of claim 1, wherein the input representing one or more of selection, arrangement, and content of the first digital on-screen graphic is from among predetermined possible inputs.

10. A method for generating digital on-screen graphics, the method comprising:
receiving, into an event application of a mobile computing device including a mobile device processor and a mobile device memory including instructions that upon execution by the mobile device processor generate the event application, input representing one or more of selection, arrangement, and content of a first digital on-screen graphic;
outputting, from the mobile computing device, event agnostic data for the first digital on-screen graphic;
receiving, into a generator computing device, the event agnostic data for the first digital on-screen graphic, the generator computing device including a generator processor and a generator memory including instructions that upon execution by the generator processor generate a rendering application; and
generating, using the rendering application, the first digital on-screen graphic from the event agnostic data for the first digital on-screen graphic.

11. The method of claim 10, further comprising:
outputting, from the generator computing device, a first generator output signal including the first digital on-screen graphic for keying to a video signal.

12. The method of claim 10, further comprising:
keying, using the generator computing device, the first digital on-screen graphic to a video signal.

13. The method of claim 11, further comprising:
receiving, into the event application of the mobile computing device, input representing one or more of selection, arrangement, and content of a second digital on-screen graphic;
outputting, from the mobile computing device, event agnostic data for the second digital on-screen graphic;
receiving, into the generator computing device, the event agnostic data for the second digital on-screen graphic;
generating, using the rendering application, the second digital on-screen graphic from the event agnostic data for the second digital on-screen graphic; and
outputting, from the generator computing device, a second generator output signal including the second digital on-screen graphic for keying to a video signal.

14. The method of claim 10, wherein the input representing one or more of selection, arrangement, and content of the first digital on-screen graphic is event specific; and
wherein the mobile device processor and mobile device memory further include instructions that upon execution by the mobile device processor generate an event database configured to receive said event agnostic data for the first digital on-screen graphic.

15. The method of claim 10, wherein the mobile computing device and the generator computing device are communicatively connected via a common network.

16. The method of claim 15, wherein the mobile computing device is communicatively connected to the common network via a wireless connection.

17. The method of claim 10, wherein the mobile computing device further includes a touch screen display to receive the input representing the one or more of selection, arrangement, and content of the first digital on-screen graphic; and
wherein the generator computing device comprises a rack-mounted computing device.

18. The method of claim 10, wherein the input representing the one or more of selection, arrangement, and content of the first digital on-screen graphic is from among predetermined possible inputs.

19. A method for generating digital on-screen graphics, the method comprising:
receiving, into an event application of a mobile computing device including a mobile device processor and a mobile device memory including instructions that upon execution by the mobile device processor generate the event application and an event database, input representing one or more of selection, arrangement, and content of a first digital on-screen graphic, where the input representing one or more of selection, arrangement, and content of the first digital on-screen graphic is event specific and where the event database is configured to receive event agnostic data for the first digital on-screen graphic;
outputting, from the mobile computing device, the event agnostic data for the first digital on-screen graphic;
receiving, into a copy of the event database running on a generator computing device including a generator processor and a generator memory including instructions that upon execution by the generator processor generate the copy of the event database and a rendering application, the event agnostic data for the first digital on-screen graphic;
generating, using the rendering application, the first digital on-screen graphic from the event agnostic data for the first digital on-screen graphic;
outputting, from the generator computing device, a first generator output signal including the first digital on-screen graphic for keying to a video signal.

20. The method of claim 19, wherein the input representing the one or more of selection, arrangement, and content of the first digital on-screen graphic is from among predetermined possible inputs.
